(19) United States
(12) Patent Application Publication
(10) Pub. No.: US 2002/0086431 A1
(43) Pub. Date: Jul. 4, 2002

(54) Sample preparation and slide plating apparatus and method

(76) Inventors: Walter Bruce Markham, Toronto (CA); Kenneth Grant Kinsman, Scarborough (CA); Jan Hendrikse, Whitby (CA); Gordon Robertson, Toronto (CA)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/931,557

(22) Filed: Aug. 16, 2001

Related U.S. Application Data
(60) Provisional application No. 60/226,510, filed on Aug. 21, 2000.

(51) Int. Cl. G01N 1/38

(52) U.S. Cl. 436/63; 422/57; 422/102; 436/174

(57) ABSTRACT

A method of collecting cells from a specimen and plating such cells onto a slide to create a monolayer. A suspension of cells is filtered to remove unwanted material and monitored to determine if a desired quantity of cells are collected. If insufficient cells are present in the filtered sample, additional suspensions of cells are serially added to the sample and filtered until a desired quantity of cells have been obtained. Devices for collecting samples of cells, for isolating a quantity of cells, and for microscopic examination of a monolayer of cells are also disclosed.

### CROSS-REFERENCE TO RELATED APPLICATIONS

The present application claims benefit of U.S. Provisional Patent Application No. 60/226,510, filed Aug. 21, 2000, the disclosure of which is incorporated by reference herein.

### FIELD OF THE INVENTION

The present invention relates to the automated preparation and plating of cytological samples in a monolayer on a microscopic slide, and to devices and components useful in these and other uses.

### BACKGROUND OF THE INVENTION

Examination of cellular material in biological specimens often requires preparation of a slide for microscope examination. Biological samples usually contain a mixture of individual cells desired to be examined (i.e., “target cells”), clumps of such target cells, non-target cells, noncellular material such as mucous, and cellular debris and cellular components. In many instances, the goal in preparing cells for cytological examination is to fabricate a slide containing a known quantity of primarily intact target cells for microscopic examination, with unwanted non-cellular material such as mucous, cellular debris and preservatives or suspension liquids removed from the specimen. One such examination is the Pap smear, the common term for the examination of a sampling from the cervix or vaginal mucosa for cancer screening. Traditional methods of screening Pap smears involves harvesting a specimen from the cervical or vaginal mucosa with a spatula or brush, plating cells on a microscopic slide, and examining the slide microscopically to determine whether there is evidence of pathology in the collected cells. Traditionally, the slide preparation and microscopic examination have been performed manually. Newer methods of screening Pap smears involve automated examination of the slides. Automated examination techniques work best with slides having consistent numbers of cells, and particularly with slides having cells arranged in a monolayer, i.e. a layer which consists predominantly of single cells or small clusters of cells distributed on a microscope slide without substantial folding or overlapping of cells. To create a monolayer on an area of a slide having a given size, the number of cells plated onto such area must be between relatively narrow limits; application of too many cells will yield a multiplayer structure, whereas application of too few cells will yield a layer with substantial gaps.

Known methods of plating a monolayer of target cells from a Pap smear include that described in Lapidus et al., U.S. Pat. No. 5,143,627 and Lapidus, U.S. Pat. No. 5,266,495. In these patents, a monolayer is created by inserting a suction unit with a screen-type filter into a cellular suspension of target cells and unwanted materials, and then suctioning the target cells onto the filter in such a manner that the cells accumulate on the filter in a monolayer. This monolayer is then transferred to a slide using a sponge as an intermediate transfer tool, or transferred directly to a slide by pressing the cell-carrying side of the filter onto the slide and applying air pressure to the backside of the filter. These patents also disclose that a specific quantity of cells can be collected in this manner since the filter area is known and the cells are dispersed on it in a single layer.

However, the methods disclosed in the Lapidus patents have drawbacks. For example, unwanted material can block the filter prior to it having accumulated a desired quantity of cells, thus collecting an inadequate sample. In addition, transfer of the monolayer to a slide requires additional steps to remove the monolayer from the filter medium, which not only add cost and complication to the procedure, but may cause less than optimum slide preparation if all of the monolayer is not completely removed from the filter surface.

Despite these efforts in the art, there have been needs for further improvements in the devices and methods used to prepare cells for analysis.

### SUMMARY OF THE INVENTION

The present invention addresses these needs.

One aspect of the invention provides methods of isolating a quantity of cells. The method according to this aspect of the invention desirably includes the step of placing a sample having an amount of target cells and unwanted material in a cuvette. Unwanted material is removed from the cuvette and a measurement of a parameter related to the number of cells in the cuvette is taken. Merely by way of example, where the cells are in a fluid suspension within the cuvette, unwanted material can be removed by filtering through a filter on the cuvette which retains the cells within the cuvette, and the parameter which is measured may include turbidity of the suspension, which can be monitored by monitoring scattering of light directed through the cuvette. If that parameter is within selected limits, a portion of the material in the cuvette is withdrawn. Preferably, if the measured parameter indicates that an insufficient quantity of cells is present in the cuvette, additional sample is placed into the cuvette and the step of removing unwanted material and measuring the parameter is repeated until the parameter is within the desired limits before withdrawing the portion of the material in the cuvette.

The portion of material withdrawn from the cuvette can be used, for example, to prepare a microscope slide or other preparation incorporating the cells. Because the number of cells in the material in the cuvette is within desired limits before this portion is withdrawn, the number of cells in the withdrawn portion will also be reasonably well controlled. The preferred methods according to this aspect of the invention can compensate for variation in the incoming samples placed into the cuvette and for variation in cell loss during the process used to remove unwanted material. For example, in the case of a Pap smear, the number of cells in a sample taken from a patient can vary considerably. The preferred processes according to this aspect of the invention can compensate for such variation. Preferred methods according to this aspect of the invention can be performed readily by automated equipment.

It is not necessary to withdraw all of the cells in the sample. In one embodiment of the method, only a subset of the sample is withdrawn from the cuvette as, for example, a predetermined volume of the sample. In a further embodiment, the subset of the sample removed from the cuvette is selected to remove a known quantity of cells from the cuvette. The measurement of the parameter related to the number of cells in the sample can be used to determine how much material is withdrawn from the cuvette. For example, for a parameter such as turbidity that is directly correlated to the number of cells per unit volume of sample in the cuvette, if it is known that given “X” parameter, “Y” amount of sample should be withdrawn, then if the measured parameter for a particular sample is ½ of “X”, 2 times “Y” amount of the sample should be withdrawn from the cuvette. In this way, the quantity of cells in the portion withdrawn from the cuvette can be controlled even more precisely.

In some embodiments of the invention, unwanted material is removed from the cuvette by filtering the sample in the cuvette through a filter sized to retain target cells within the cuvette.

In another embodiment where unwanted material is removed by means of a filter, which traps the cells in the cuvette but passes the unwanted material, the parameter being measured to determine whether there are sufficient cells in the sample is the fluid flow resistance through the filter. As the target cells collect on the filter, the filter resistance increases. Thus in this embodiment, an increase in filter resistance indicates an increase in the number of target cells in the sample.

In certain embodiments of the invention, the material remaining in the cuvette after removing unwanted material is resuspended by introducing a fluid into the cuvette prior to measuring a parameter of the sample related to the number of target cells in the sample. Resuspending facilitates accurately measuring the desired parameter of the sample and therefore the number of target cells in the sample.

Still further aspects of the invention provide methods, which can automatically compensate for unusual conditions encountered with some samples in a series of samples. In methods according to this aspect of the invention, a series of samples having target cells are each individually suspended in a fluid, transferred to a cuvette, and then unwanted material removed. For at least some of these samples, a parameter of the sample is measured. As discussed above, such parameter is related to the number of target cells in the cuvette; if the parameter indicates that a predetermined quantity of cells are not present in the sample, additional sample is placed in the cuvette, unwanted material is removed, and the parameter related to the number of target cells in the cuvette is measured again. Here again, where the measured parameter indicates that a predetermined quantity of cells are present in the sample, a portion of the sample is withdrawn and transferred to a slide or other final preparation. In some embodiments of the method according to this aspect of the invention, a “time-out” function is used to control the step of removing unwanted material from the sample. For example, where the step of removing unwanted material from a particular sample cannot be completed in a preselected time, the system may withdraw a portion of that sample from the cuvette and transfer that portion to a slide. The transfer actuated in response to the time-out function can occur, without measuring any parameter of the sample, or if a parameter of that sample is measured, regardless of the indication provided by the measured parameter. In a further variant, if the measured parameter for a particular sample does not fall within the desired limits after a predetermined number of repetitions or after a predetermined time, a portion of the sample is withdrawn and transferred regardless of the measured parameter.

In methods according to a further aspect of the present invention, a fluid suspension including target cells and unwanted material is placed in a cuvette and unwanted material is removed for a certain predetermined period of time. After this period of time and regardless of any parameter of the sample remaining in the cuvette at that time, a portion of such samples are withdrawn from the cuvette and transferred to a slide. The predetermined period of time may be based on a measurement taken of a parameter of the sample related to the number of target cells in the sample, such measurement being taken prior to or during the step of removing any unwanted material from the sample. In yet a further embodiment, the predetermined period of time is based on a measurement taken of a parameter of the sample related to the amount or quality of unwanted material present in the sample.

A further aspect of the invention provides methods of collecting target cells from a suspension. A method according to this aspect of the invention desirably includes introducing the cells into a container having a filter sized so that cells cannot pass through the filter, passing fluid flows through the filter in an alternating downstream and upstream directions through the filter. This alternating movement of fluid through the filter facilitates mixing of the material in the cuvette and reduces blockage of the filter.

In cell collecting methods according to another aspect of the invention, cells are collected in a container having a filter sized so that cells cannot pass through the filter.

In yet another aspect of the invention, cells are collected by filtering a quantity of cells and a fluid in a container having a “choke” upstream of the filter. The choke is a constriction in the cross-sectional area of the container relative to the areas of the container upstream and downstream from the choke. As fluid moves through the choke, turbulence is generated in the fluid. Such turbulence facilitates mixing of the cells and fluid in the container. Turbulence in the container caused by the choke can also help reduce clogging of the filter. Collecting methods as discussed in connection with these aspects of the invention can be used, for example, in the step of removing unwanted material in the methods of isolating a quantity of cells as discussed above.

A still further aspect of the invention provides a sample vial or container for retaining and mixing specimens. The sample vial desirably includes projections inside the sample vial. The projections can be arranged to act as scrapers to enhance the transfer of collected specimens to the sample vial. The projections can also serve to increase turbulence in the sample vial when the sample vial is shaken or rotated, thus increasing the mixing of materials placed into the sample vial.

A still further aspect of the apparatus provides apparatus for collecting cells from a liquid. The apparatus may include a cuvette having an opening at one end for introduction of specimen material, and a filter on the other end where fluid and unwanted material can be withdrawn from the cuvette. Above the filter, a choke is provided as previously described. As previously described, this choke increases the turbulence in the fluid above the filter to increase mixing and reducing filter blockage. A further aspect of the invention provides apparatus, which includes a container such as a cuvette having a filter and a pipette that fits within the cuvette so that when the pipette and cuvette are assembled with one another, the tip of the pipette is disposed close to, but does not extend through, the filter. The cuvette in this aspect as well may include a choke, and the pipette desirably extends into the choke when the pipette and cuvette are assembled to one another. Situating the discharge of the pipette close to the filter, such as between the choke and the filter increases turbulence of the fluid, thereby increasing mixing of the contents of the cuvette. This advantage is particularly pronounced in the case where the cuvette includes a choke and the pipette extends through the choke. Also, discharge of fluid from the pipette proximate to the filter reduces caking of the filter by using the force of the fluid discharge to “wash” the surface of the filter.

It should be appreciated that the combination of the cuvette with a choke and the pipette as described herein to introduce fluid between the choke and filter function synergistically to improve mixing and reducing blockage of the filter. Each of the described cuvettes and pipettes, however, can also work independently and separately to improve mixing and reduce blockage of various filtering and cell collection apparatuses.

A further aspect of the invention provides a microscopic slide coated with adhesive to assist in bonding cells onto the slide, and having a containment area around such adhesive with a lower surface energy than the area of the slide within the containment area. For example, this containment area can include a hydrophobic material. Such a slide can be used in preparation of a cell monolayer as, for example, by transferring a liquid suspension of cells onto the adhesive-coated area.

Further embodiments of the invention include methods of removing excess sample from the slide, including draining excess material by tilting the slide, blotting excess from the slide, or aspirating excess sample from the slide.

These and other objects, features and advantages of the present invention will be more readily apparent from the detailed description of the preferred embodiments set forth below, taken in conjunction with the accompanying drawings.

### BRIEF DESCRIPTION OF THE DRAWINGS

FIG. 1 is flow-chart of the steps and decision points in one embodiment of the method of the invention.

FIG. 2 is a cut-away view of the specimen container according to a further embodiment of the invention.

FIG. 3 is a perspective view depicting the inside of the specimen container in FIG. 2 according to a further embodiment of the invention.

FIG. 4 is a perspective view of the pipette according to a further embodiment of the invention.

FIG. 5 is an enlarged fragmentary perspective view of the tip of the pipette of FIG. 4 according to a further embodiment of the invention.

FIG. 6 is an enlarged fragmentary sectional view of features inside the tip of the pipette of FIG. 5.

FIG. 7 is a diagrammatic view of the pipette of FIG. 4 positioned for insertion relative to a cuvette and filter according to a further embodiment of the invention.

FIG. 8 is a sectional view of the pipette and cuvette of FIG. 7 according to a further embodiment of the invention.

FIG. 9 is a perspective view of the pipette according to another embodiment of the invention.

FIG. 10 is a perspective view of the pipette in FIG. 9 inserted into a cuvette according to another embodiment of the invention.

FIG. 11 is a diagrammatic view of a microscopic slide according to a further embodiment of the invention.

FIG. 12 is a piping chart of according to a further embodiment of the invention.

### DETAILED DESCRIPTION

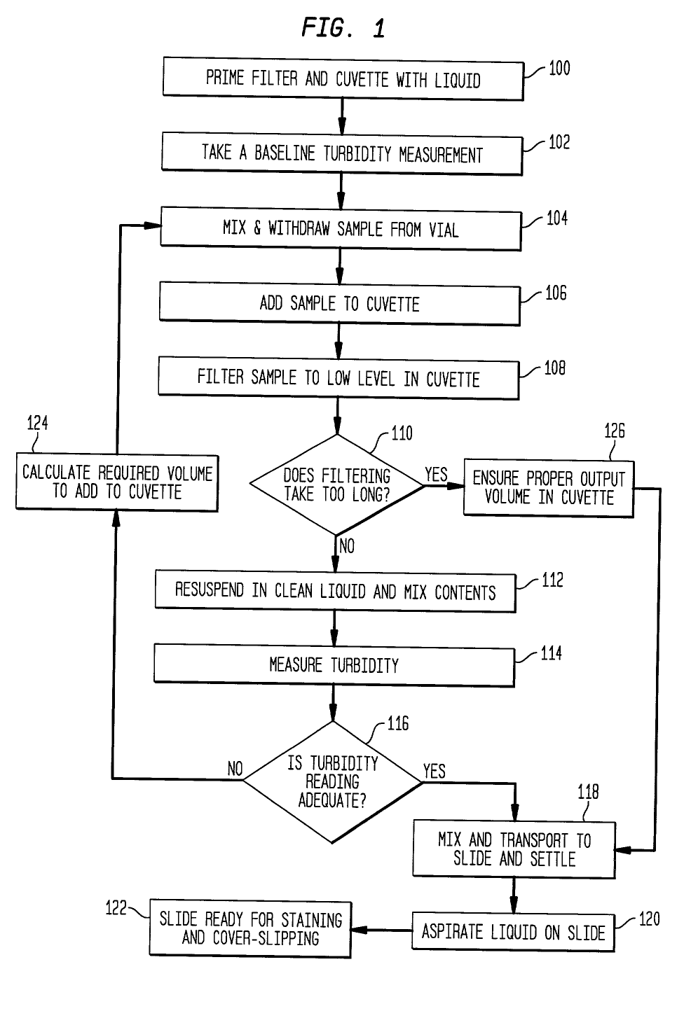

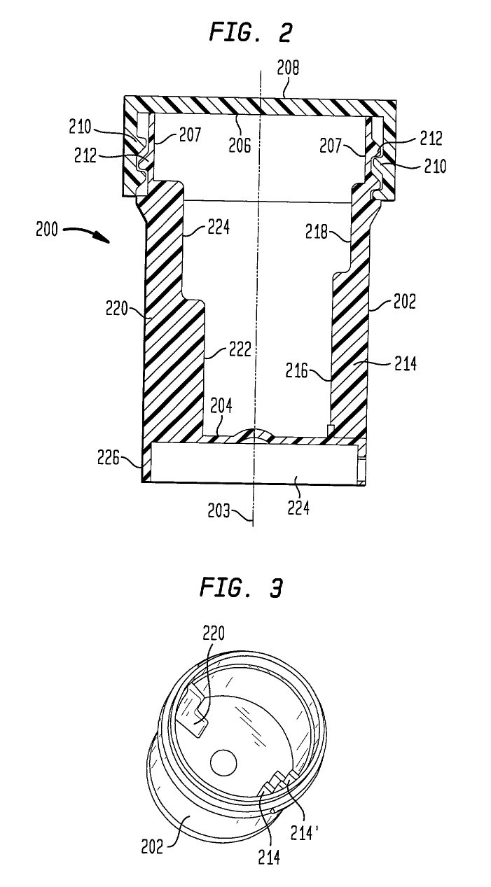

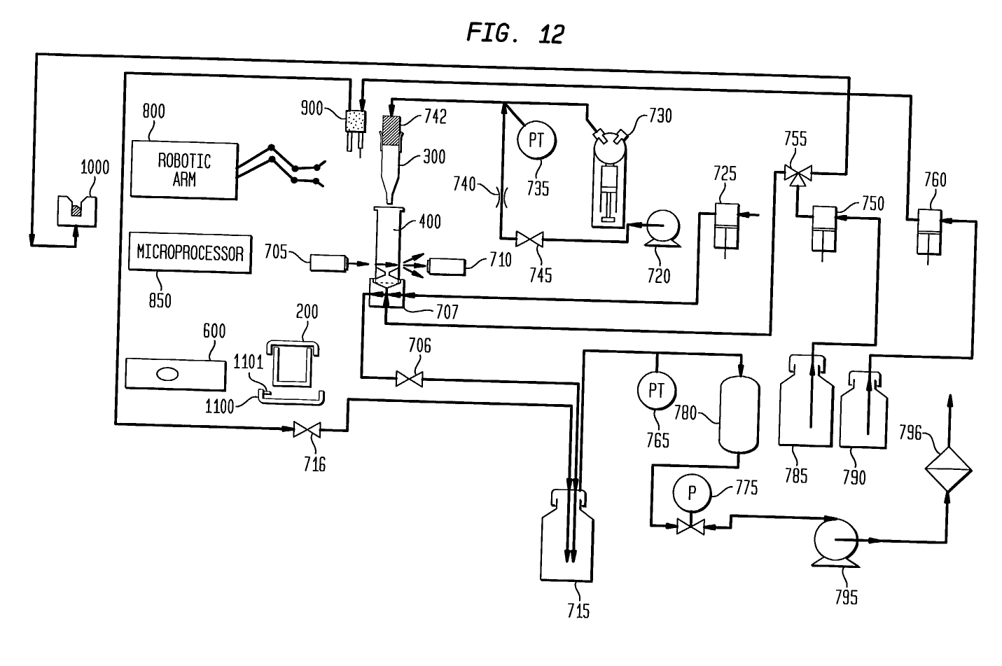

The general steps of the method of the presently preferred embodiment of the invention are shown in a flow chart in FIG. 1, with rectangular boxes representing steps in the preferred method and diamond boxes representing decision points between steps. The method of the preferred embodiment utilizes a novel sample vial, cuvette, pipette, and slide, shown in FIGS. 2 through 11, which are described below, and also utilizes the apparatus shown in FIG. 12. Preferred embodiments of the apparatus will be first described, followed by a description of the preferred method steps.

### Sample Vial

The sample vial 200 shown in FIGS. 2 and 3 has a generally cylindrical side wall 202 having an axis 203, a bottom wall 204, an opening 206 opposite the bottom wall 204 of the sample vial. A cap 208 is releasably connected to the upper portion 207 of the side wall 202 by means of threads 212 on the inside of the cap 208 that mate with threads 210 on the outside of the upper portion 207 of the side wall 202. When the threads 212 of the cap 208 are engaged with the threads 210 of the sample vial, the cap covers the opening 206.

The sample vial 200 is provided with projections 214 and 220 that extend from the sidewall 202 into the interior of the sample vial. The projection 220 is “stepped” in that it has a lower section 222 that extends further into the inside of the container than an upper projection 224. At the bottom of the sample vial, the projection extends approximately 7 mm from sidewall 202 into the interior of the sample vial. At the top of the projection, the projection extends approximately 4 mm from sidewall 202 into the interior of the sample vial. Such projections assist in the transfer of sample material into the sample vial and facilitate mixing of material within the sample vial when it is rotated or shaken. As shown in FIG. 3, a composite projection 214 is comprised of a pair of projections 214 and 214′. As shown in FIG. 2, these projections 214 and 214′ are disposed substantially vertically along the side of the sample vial 202 and extend from the bottom 204 of the sample vial to a point below the uppermost portion 206 of the sidewall of the sample vial. At the bottom of the sample vial, projections 214 and 214′ extend approximately 4 mm from the sidewall 202 into the interior of the sample vial. At the top of the sample vial, the projections extend approximately 2 mm from the sidewall 202 into the interior of the sample vial. The projections 214 and 214′ are separated by a distance of from 1 mm to 6 mm to facilitate the removal of specimens from brooms or brushes typically used to harvest cellular specimens from the body. The projections also facilitate mixing of the contents of the sample vial. The projections are “stepped,” such that projection 214 and 214′ have a lower section 216 that extends into the inside of the container a greater distance than an upper section 218.

The sample vial has a recess 224 defined by a portion of sidewall 202 extending downwardly beyond they bottom wall 204. Recess 204 is designed to mate with a corresponding protrusion on an automated machine. The downwardly extending portion of sidewall 202 includes a hole or indentation 226 below sidewall 204.

In the preferred embodiment, the sample vial and cap 204 are injection molded from a polymer such as polypropylene and are disposable to avoid cross-contamination.

### Pipette

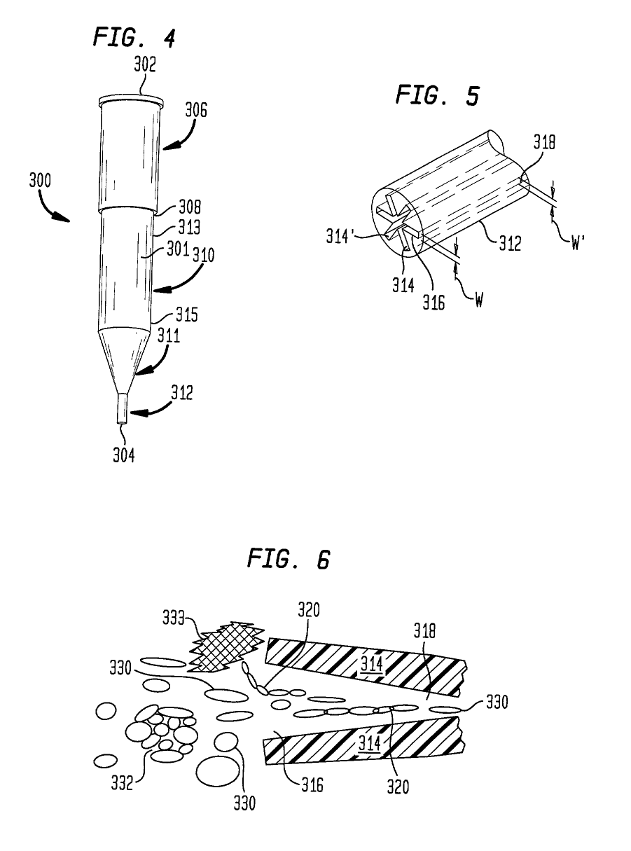

A pipette 300 (FIG. 4) has a hollow, generally tubular body 301, an opening 302, a tip 312, and a discharge end 304 at the end of the tip 312 opposite the opening 302. Such discharge end 304 allows material to be drawn into the pipette and discharged out of the pipette. The body 310 has an upper section 306, which is of a greater diameter than a middle section 310, and a ledge 308 extending outwardly from middle section 310 to upper section 306. The ledge 308 is wider in diameter than any part of the body of the pipette between the ledge 308 and the discharge end 304 of the pipette. Between the middle section 310, and the tip 312 of the pipette is a lower funnel section 311, which tapers from a larger diameter at its joinder with the middle section 310 to a narrower diameter at its joinder with the tip 312. The tip 312 is elongate, having a length of about 7 mm and an exterior diameter of about 0.8 mm, commonly referred to as a “capillary termination.” The opening of the discharge end is approximately 1 mm in diameter. The diameter of the middle section 310 tapers from a larger diameter section 313 adjoining the upper section 306 to a narrower diameter section 315 adjoining the lower funnel portion 311.

In the preferred embodiment, the pipette is injection molded from an inert polymer such as polypropylene and is disposable to avoid cross-contamination.

### Cuvette

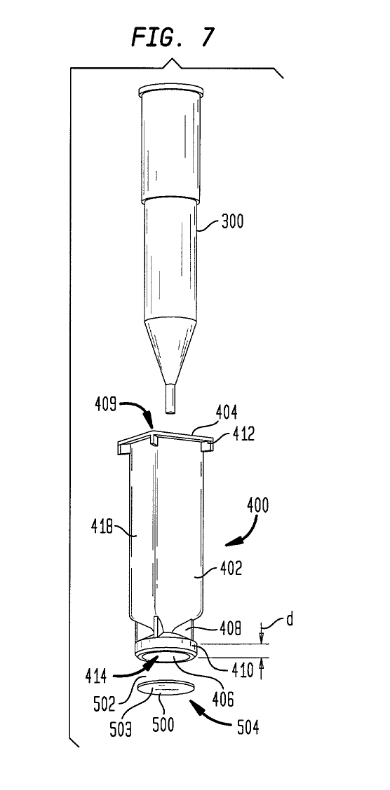

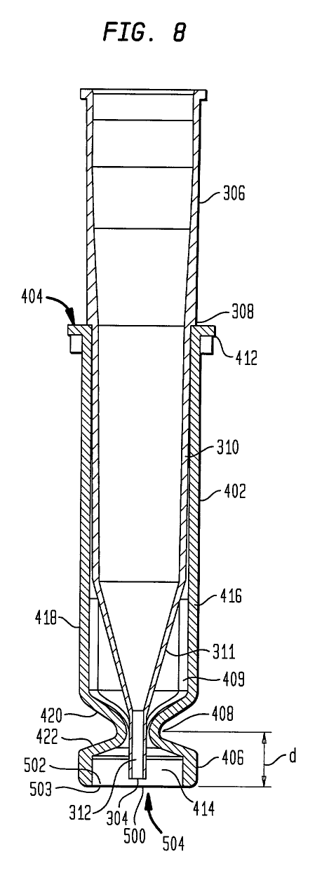

A cuvette 400 as depicted in FIGS. 7 and 8 has a hollow, generally rectangular body 402, with generally parallel sides 416 and 418. The body has a main interior space 409 and an opening communicating with the main interior space at an upstream end 404. The cuvette has a downstream or discharge end 406 opposite from the upstream end 404. A filter 500 is attached to the discharge end 406 to allow material placed into the interior of the cuvette to be filtered. The filter 500 desirably is a size-selective filter having a relatively sharp retention cutoff. That is, the filter desirably will allow nearly all particles below a preselected size to pass through, but will retain nearly all particles above such size. Preferably, the filter is a track etched membrane filter sized to allow unwanted material to pass through the filter and target cells to be retained in the cuvette. Most preferably, the filter is a polycarbonate track-etched membrane filter with a thickness of about 12 microns and a pore diameter of about 8 microns. The filter is preferably thermally or ultrasonically welded to the cuvette. The filter has an upstream side 502 facing the interior 409 of the cuvette and an opposite downstream side 503.

The cuvette has a choke 408 between the main interior space 409 and the filter 500. The choke is positioned in the cuvette near the discharge end 406 but disposed a sufficient distance (“d”) from such end so that a chamber 414 is created within the interior of the cuvette between the filter 500 and the choke 408. In the preferred embodiment, this distance is approximately 6 mm. The chamber 414 is circular in cross-section.

The choke has a narrower interior cross-section than the main portion 409 upstream of the choke (above the choke as seen in FIG. 8) and chamber 414 downstream of the choke. For example, the interior cross-sectional area of the choke may be about 0.07 cm², whereas the interior cross-sectional area of the main portion 409 may be about 1 cm², and the interior cross-sectional area of chamber 414, in its circular portion immediately upstream of filter 500, may be about 0.78 cm². As can be seen in the cross-sectional view in FIG. 8, the top wall 422 of the chamber 414 is tapered or curved to provide a gradual transition in diameter between the choke 408 and chamber 414. This decreases the likelihood that air introduced into the chamber will be trapped in the chamber. At least two parallel sides 416 and 418 of the body 402 of the cuvette are substantially transparent to a light used for turbimetric examination of material within the cuvette. In alternate embodiments, the entire cuvette or the portion of the cuvette where turbidity is measured can be cylindrical.

As shown in FIGS. 7 and 8, the top of the cuvette 400 includes a ledge 412 that is designed to mate with the ledge 308 of the pipette 300 to limit the distance that the pipette 300 can be inserted into the cuvette 400.

The pipette 300 and the cuvette 400 are designed so that the pipette can be inserted into the cuvette so that the pipette and cuvette can be transported together. When the pipette 300 is fully inserted into the cuvette 400, with ledge 308 of the pipette engaged with flange 412 of the cuvette, the elongate tip 312 of the cuvette passes through the choke 408 of the cuvette, so that the discharge end 304 of the pipette is positioned in the chamber 414 of the cuvette between the choke 408 and the filter 500. When the pipette is inserted into the cuvette in this manner, the discharge end 304 is preferably positioned 0.5 mm from the filter 500. Penetration of the pipette into the cuvette is limited by the mating of the ledge of the pipette 308 with the ledge of the cuvette 412. As can be seen in FIG. 8, the lower portion 420 of the wall of the cuvette proximate to the choke 408, forming the junction between the main portion 409 and the choke on the upstream side of the choke, is tapered to guide the tip 312 of the pipette through the choke 408. The tapered middle portion 310 of the pipette fits into the interior of the main portion 409 of body 402 of the cuvette.

In the preferred embodiment, the cuvette is injection molded from a clear polymer which does not contaminate the materials to be processed as, for example, from polystyrene or acrylic and is disposable to avoid cross-contamination.

### Microscopic Slide

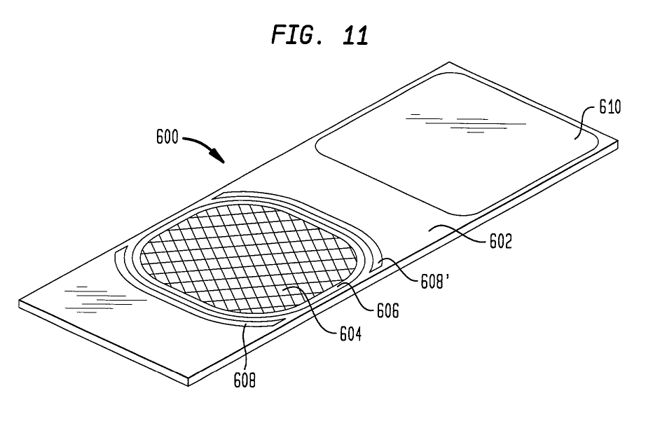

A microscopic slide 600 (FIG. 11) is formed from glass or other transparent material and has a top or operative surface 602. A portion of the surface 602 is coated with a cellular adhesive 604, preferably a UV polymerizable adhesive or a polycationically charged polymer, such as poly-allyl-amine*HCl (“PAA”) or poly-L-lysine (“PLL”) transparent to visible light. A containment boundary 606 is provided around the adhesive coated area 604. The containment boundary is made of a hydrophobic material, such as a wax, polyolefin, silicon based polymer, halogenated polymer, a halogenated silane, of as, for example, a flourosilane copolymer, or a halogenated hydrocarbon of as, for example, a halogenated polymer of the type sold under the registered trademark Teflon coating. Desirably, the hydrophobic polymer is provided in the form of a coating occupying a region on the surface approximately 1 mm to 10 mm wide. The coating desirably is transparent to visible light. An epoxy resin may be further used to better adhere the hydrophobic material to the slide.

The adhesive coated area 604 and the containment boundary 606 are transparent to visible light so that when the slide is subject to microscopic examination under visible light, neither the containment area nor the adhesive coating obscures viewing of the cells placed on the slide. In further embodiments, the light for microscopic examination could include ultraviolet, infrared, or other spectra, and depending on the spectra of light being used for examination, the material for the adhesive or containment boundary, as well as the material of the slide body 600, are selected so that such containment boundary is transparent to the spectra of light used for microscopic examination.

Opaque areas 608 and 608′ surround the containment boundary 606 and adhesive coated area 604. These opaque areas assist a person examining the slide to determine where the cell sample has been placed on the slide. These opaque areas can also be used in embodiments where the slide is read by a machine to facilitate robotic positioning of the slide for automated viewing. A further indicia area 610 of the slide is roughened or coated with a material that can be easily written upon to allow the slide to be more easily marked to indicate information about the specimen or an identification about the patient from whom the specimen was taken.

### Processing Apparatus

A processing apparatus as shown in FIG. 12 is also provided to perform the preferred method on a series of samples. The apparatus is used in conjunction with a sample vial 200, pipette 300, cuvette 400, and microscopic slide 600, each discussed above. The apparatus includes a dispense/aspirating head 900, a wash station 1000, and a mixing apparatus 1100. A robotic arm 800, is provided to move the sample vial 200, pipette 300, cuvette 400 and dispense/aspirating head 900. A control computer or microprocessor 850 is also provided. The control computer is connected to robotic arm 800 for controlling the arm. The control computer is also connected to the other sensors and controllable elements of the apparatus described below, and is programmed to actuate the elements of the apparatus to perform the functions discussed below, in the sequence described. Although a single control computer is depicted for simplicity, the functions of the control computer may be split among two or more separate control computers or other control elements. Merely by way of example, some or all of the functions of the control computer can be performed by pneumatic, hydraulic, mechanical or electromechanical control elements such as cams, limit switches, solenoids, discrete logic elements and linkages.

The apparatus further includes a multi-port cuvette block 707. As further explained below, the discharge end 406 of each cuvette is mated with block 707, and fluids are transferred between the cuvette and other elements of the system through block 707. Block 707 has a cuvette port arranged to temporarily engage the discharge end of a cuvette and to form a seal with the discharge end, and also has other ports communicating with the cuvette port. These other ports are connected to other elements of the system as discussed below. The cuvette port of block 707 desirably is equipped with O-rings or other resilient seals (not shown) for engaging the cylindrical exterior surface of the cuvette discharge end 406. The apparatus also may include grips or supports (not shown) for temporarily engaging and supporting each cuvette while such cuvette is engaged with block 707.

The apparatus includes a filtrate/waste container 715 connected to vacuum reservoir 780. Such vacuum reservoir is connected to a vacuum pump 795, and monitored by a vacuum regulator 775 to maintain constant subatmospheric pressure in the vacuum reservoir 780. A pressure sensor 765 between the vacuum reservoir 780 and a filtrate/waste container 715 is used to monitor the pressure in the filtrate/waste container. A filter 796 is provided to filter discharge air from the vacuum compressor.

Sources of fluid are provided in the apparatus of FIG. 12. Such sources include a water source in a reservoir 785, and an alcohol source in a reservoir 790. The water source in reservoir 785 is connected to the multi-port cuvette block 707 through a piston pump 750 and valve 755. The water source 785 is also connected to probe wash station 1000 through such valve 755. The alcohol source 790 is connected to the dispense/aspirate head 900 through a further piston pump 760.

A light source 705 such as an light emitting diode or laser, and a light sensor 710 such as a photocell, are mounted adjacent block 707 such that when a cuvette 400 is engaged with block 707, the path of light from generator 705 to sensor 710 passes through parallel sides 418 and 416 of the cuvette main portion 409. A conventional power supply or drive circuit (not shown) is associated with the light source. A conventional signal processing circuit (not shown), which may include elements such as amplifiers and digitizers, is associated with sensor 710, for providing a signal representative of the amount of light passing through the cuvette. As further explained below, this signal provides a measure of the turbidity in a sample within the cuvette.

The robotic arm 800 is controlled by the microprocessor 850 to alternately move the sample vial 200, the pipette 300 m cuvette 400, slide 600, and dispensing aspirating head 900, as will be described below. The control computer also controls other parts of the automated apparatus including timing, dispensing fluids, applying and regulating vacuum and pressure sources, measuring turbidity, and determining or measuring other parameters of the method.

Pressurized air is by a piston pump 725 connected to the multi-port cuvette block 707. A second source of pressurized air is provided by a pump 720, connected through a valve 745 and a restrictor 740 to a port in a stopper 742 which is adapted to fit into the opening 302 of a pipette 300. A syringe pump 730 is also connected to the pipette to the port of stopper 742. A pressure sensor 735 is connected to the bore of the stopper 742. The dispensing/aspirate head 900 is connected to the filtrate/waste container 715 through a valve 716.

### Preferred Methods of the Invention

Some of the steps of practicing the method of the invention are shown illustratively in the flow chart in FIG. 1. Referring to FIG. 1, in a first step 100, a cuvette 400 is engaged with block 707 and is primed with a liquid from reservoir 785, most preferably distilled water. The liquid used for priming is pumped by pump 750 through block 707 and passes upstream through the filter of the cuvette. This action also fills the space within block 707 with the priming liquid.

In a next step 102, a baseline measurement of turbidity of the cuvette filled with the priming liquid is taken for use in comparing such a measurement to a later measurement of turbidity after sample is introduced into the cuvette in a step 114 described below. The measurement of turbidity is taken by directing a beam of light from transmitter 705 to light sensor 710, through the substantially parallel transparent sides 416 and 418 of the cuvette 400 at a point just above the choke 408. The signal representing the amount of light passing through the cuvette gives a baseline turbidity measurement.

A sample vial 200 holding a specimen from a patient is provided. For example, the specimen in vial 200 may be a specimen collected in a conventional Pap smear procedure. The specimen is typically collected from a patient with collection devices such as spatulas, brooms, brushes or the like. Where the specimen was collected by a spatula, projection 220 facilitates scraping of the specimen into the interior of the sample vial. Where the sample was collected by brush, composite projection 214 and 214′ facilitates scraping of the specimen into the sample vial. In the preferred embodiment, the contents of the sample vial is a fluid suspension including target cells, mucous, unwanted material such as cellular debris and red blood cells, and a preservative solution. The preservative solution may be present in the vial before collection of the sample, or may be added to the vial as a part of the sample collection procedure. In alternate embodiments, only cells and unwanted material are present in the sample and a fluid such as distilled water or a preservative solution are added to the sample vial containing target cells and unwanted material so as to create a fluid suspension within the container.

In a next step 104, the content of the sample vial 200 is mixed. Mixing of the sample vial in step 104 is achieved by placing the sample vial 200 on a rotatable member of mixing apparatus 1100. Preferably, this step is performed automatically, using robotic arm 800. The sample vial is placed in the mixing apparatus so that the recess 224 in the bottom of the sample vial mates with the rotatable member of the mixing apparatus. A projection 1101 on the rotatable member of the mixing apparatus mates with the aperture or indentation 226 in the side of the sample vial to assist in transferring movement of the rotatable member of the mixing apparatus to the sample vial 200. Mixing is accomplished by rotating the sample vial around its cylindrical axis 203 (FIG. 2) in a alternating clockwise and counterclockwise direction at a sufficient speed to generate shear forces within the vial. The mixing apparatus 1100 desirably includes a reversible electric motor or other suitable drive (not shown) for spinning the rotatable member. The stepped projections 214 and 222 increase the turbulence in the sample vial and therefore the mixing of the fluid suspension within the sample vial. The shear forces and turbulence created by the alternating rotation of the sample vial and the projections also facilitate disaggregation of clumps of cells or unwanted material within the specimen vial.

After mixing of the fluid suspension in the sample vial, the tip 312 of a pipette 300 as described above is inserted into the fluid suspension within the sample vial 200. Air supplied by pump 720 is bubbled through the pipette 300 into the fluid suspension to further mix the contents of the sample. In further embodiments, rotating the sample vial 200 is done simultaneously with the introduction of air though the tip of the pipette 300. In still further embodiments, a syringe with needle attached thereon, or a pipette with a suitably long and narrow termination, is lowered into the sample vial by the robotic arm 800 and sample is drawn into and pushed out of the syringe through the needle or pipette to break up clumps of cells or aggregates of unwanted material.

A known volume of the fluid suspension in the sample vial 200 is then suctioned through the discharge end 304 of the pipette 300 into the interior of the pipette. Suction is generated by pump 730 and monitored by pressure sensor 735.

In a following step 106, the pipette 300 is withdrawn from the sample vial 200 and positioned above the cuvette 400 engaged with block 707 with the discharge end 312 of the cuvette approximately at the opening 404 of the cuvette. Such movement and positioning are accomplished by the robotic arm 800. The sample withdrawn from the sample vial 200 into the pipette 300 in step 104 is then introduced into the interior 409 of the cuvette 400.

In a next step 108, the sample in the cuvette is filtered to a low level. Such filtering is achieved by opening valve 706 so as to apply suction from vacuum reservoir 780 to the downstream side 504 of the filter 500. Filtrate is collected in the filtrate/waste container 715. The filtrate contains unwanted materials such as mucus and liquid including the preservative solution included in the original sample and the water or other priming liquid previously introduced into the cuvette. The desired cells collect on the upstream side 502 (FIG. 8) of the filter.

During the filtration step 108, the filtrate flows in the downstream direction, from the interior of the cuvette into block 707 and hence flows from the upstream side of filter 500 to the downstream side. The cuvette is backwashed with air from pump 725 by introducing air into the cuvette through the multi-port cuvette block 707 from the downstream side 504 of the filter 500 to the upstream side 502 of the filter 500. Pump 725 provides metered volumes of pressurized air at a frequency of about 0.1 to about 50 Hz, and most preferably in a frequency of about 0.2 to about 1 Hz. During application of each such pulse, the pressure within block 707 rises momentarily, so that fluid flows upstream through the filter, from the downstream side 503 to the upstream side 504. Thus, backflushing and filtration alternate to simultaneously clear the filter through a “rippling” action, further mix the contents of the cuvette, and avoid caking of cells and other materials on the filter surface. The backflushing fluid passing upstream through the filter includes a significant amount of air introduced by pump 725, and may also include some filtrate. Some of the air forms bubbles which rise through the cuvette and escape through the opening of the upstream end of the cuvette.

The sample is filtered until nearly all of the fluid in the sample is withdrawn from the cuvette. The determination of when all of the fluid has been withdrawn from the cuvette is made by monitoring light scattering in the cuvette with the same light emitter 705 and light sensor 710 used to determine the base level of turbidity in step 100. During the filtering process, backflushing creates bubbles in the fluid in the cuvette. The bubbles scatter light, so that the signal from sensor 710, and thus the apparent turbidity of the sample in the cuvette, increases to a “peak” level and fluctuates. As long as there is a substantial amount of liquid present in the cuvette, this high apparent turbidity level will persist. When substantially all of the liquid has been removed from the cuvette through the filter, the space within the cuvette main portion is filled with air, and is substantially devoid of bubbles, so that the light from source 705 is no longer scattered by bubbles. Thus, the apparent turbidity of the sample as measured by sensor 710 drops to a low level. Accordingly, the cuvette is subjected to filtration until the end point at which no such peaks are detected, and the apparent turbidity declines. At this end point, after all of the fluid and unwanted material is filtered from the cuvette, substantially only target cells remain in the cuvette.

The duration of the filtration step 108 is timed by the microprocessor or control computer 850. As shown in the decision point 110 of FIG. 1, if the filtering step 108 takes longer than a predetermined period of time, so that the above-mentioned end point is not detected within this predetermined period, filtering is ceased at the end of this period. This predetermined period is long enough that the end point is typically reached during the period. For example, the period may be about 3 minutes. Thus, a typical sample will reach the end point within the predetermined period, and will then be subjected to step 112 discussed below. Those samples which do not reach the end point within the predetermined period are subjected to an alternative process step 126.

In alternative process step 126, the fluid level in the cuvette 300 is measured to determine if there is adequate fluid in the cuvette. The fluid level is determined by lowering the pipette 300 into the cuvette 400 by the robotic arm 800 and simultaneously applying suction to the pipette. During such insertion of the pipette into the cuvette, the pressure in the pipette is monitored through sensor 735, while the distance that the tip of the pipette is inserted into the cuvette is simultaneously monitored. When the tip 312 of the pipette reaches the surface of the fluid in the cuvette, the pressure within the pipette changes, thus indicating the level of fluid within the cuvette. In alternate embodiments, measurement of the fluid level in the cuvette is accomplished by a capacitive level sensor. If there is not adequate fluid in the cuvette, then additional water from reservoir 785 is added to the cuvette to ensure there is an adequate level of fluid in the cuvette. Water is added to the cuvette by pumping water from reservoir 785 through multi-port block 707 into the cuvette.

The control computer “tags” each sample subjected to the alternative processing step 126 as a sample which cannot be filtered using the normal procedures. The control computer can record such a result in any form which can be correlated to a particular sample. For example, where each sample has an identification number, the control computer can record the identification numbers of those samples for which this result occurs. Alternatively or additionally, the control computer can actuate a marking device (not shown) to mark the slide prepared from each such sample in step 118, discussed below, with a physical mark indicating that the sample was prepared using the alternative process step.

In step 112, a known quantity of a resuspending liquid such as distilled water is then added to the cuvette by pumping water from the reservoir 785 through multi-part block 707 into the cuvette. To further mix the sample within the cuvette, a “pipette mixing” step is conducted. In such pipette mixing step, the robotic arm 800 inserts the pipette into the cuvette and fluid within the cuvette is drawn into the pipette and then discharged back into the cuvette. During such intake and discharge, the pipette tip 312 is positioned between the choke 408 and the filter 500, with the discharge end 403 of the tip of the pipette approximately 4.5 mm from the filter 500. Discharge of the fluid in this position creates turbulence in the fluid within the chamber between the choke 408 and the filter 500 which facilitates mixing the sample in the cuvette, both above and below the choke. Such turbulence is generated not only from the fluid effects of the sample fluid being introduced into the relatively small chamber 414, but from the turbulent effects of fluid passing through the choke and around the tip of the pipette inserted in the choke. Such turbulence facilitates the resuspension and mixing of the cells remaining in the cuvette and clears or washes the upstream side of the filter to free any cells lodged thereon. Liquids other than distilled water, such as a preservative solution, can be used to resuspend the material remaining in the cuvette. Distilled water is the preferred resuspending liquid, because it allows the cells to better settle and adhere to the slide. In alternate embodiments, a lysing agent such as acetic acid in water at pH 3 is added to the cuvette in step 112 to break down red blood cells remaining in the cuvette. In still further embodiments where a lysing agent is used, a buffer at pH 8.5 such as n-[Tris (hydroxymethyl) methyl]glycine is used to aid in restoring adhesive properties of the cells if such adhesive properties were diminished through the use of a lysing agent. In still further embodiments, a solution of water and ethanol can be used.

In a following step 114, the turbidity of the fluid in the cuvette is measured by the same method and equipment describe in relation to steps 102 and 108 discussed above. In the most preferred embodiment, the turbidity is measured immediately above the choke 408. The turbidity of the sample is directly correlated to the number of cells per unit volume in suspension in that portion of the sample which intercepts the light beam passing from source 705 to sensor 710. The mixing action discussed above during the resuspension step helps to assure that the turbidity measurement accurately reflects the overall composition of the sample. As the baseline turbidity measurement is known from step 100, and the amount of fluid in the sample is known from step 112, the control computer 850 can calculate from known values the number of cells in the sample within the cuvette after step 114. If the turbidity reading indicates that a sufficient number of cells are present in the sample, the sample is subjected to a mixing and transporting step 118 discussed below. Samples where the turbidity reading indicates that an insufficient number of cells are present in the sample are subjected to the following step 124.

In step such 124, an additional amount of sample material is withdrawn from the sample vial 200 by pipette 300 and added to the cuvette 400 to increase the number of cells in the cuvette. In a preferred embodiment, the amount of material to withdraw from the cuvette is calculated as follows: As was discussed above with regard to steps 104 and 106, a known portion of material was withdrawn from the sample vial and introduced into the cuvette. The sample within the vial 200 was thoroughly mixed in step 104. Thus, the original sample withdrawn from the sample vial in step 104 was relatively typical in terms of number of cells per unit volume of the specimen in the sample vial. As the number of cells in the sample was estimated in step 116 discussed above, it is possible to estimate the number of cells per unit volume of fluid suspension in the sample vial 200 by dividing the calculated number of cells in step 116 by the volume of sample removed from the cuvette in step 104. The volume of sample needed to be withdrawn from the sample vial and added to the cuvette can now be calculated from such measurement so as to make up for any deficiency of cells present in the cuvette.

By way of example only and without limitation, the following example is provided: Assume for this example that it is desirable to collect 1000 cells, 10 ml of material was withdrawn from the sample vial in step 104, and it was determined in step 116 that 800 cells were present in that 10 ml portion of the sample. Since it was known that there were 800 cells per 10 ml of sample removed from the sample vial, it can be estimated that there are 80 cells per ml of sample in the sample vial. As 1000 cells are desired and only 800 are presenting the cuvette, another 200 are needed to be introduced into the cuvette. Dividing 200 cells by 80 cells per ml of sample results in an estimated 2.5 ml of sample that needs to be withdrawn from the sample vial to add 200 cells to the cuvette. In this way the required volume to add to the cuvette can be calculated.

For such samples where additional material needs to be added to the cuvette, the calculation in step 124 is made and steps 104 and 106 are repeated. In such repetition, syringe pump 730 is actuated to transfer the calculated amount of material from vial 200 to cuvette 400. After steps 104 and 106 are repeated, steps 108 through 116 are preformed. Here again, this sequence of steps can be interrupted at step 110 if the filtration in step 108 takes too long. In this case, the sample is subjected to the alternate processing step 126 discussed below. In the normal case, however, the sample is subjected to all of steps 108 through 116 again. If the turbidity reading in the repeated step 116 indicates that an adequate number of cells is present, the sample is subjected to step 118. If not, the calculation step 124 is performed again and the cycle of steps 104-116 is repeated again. The control computer keeps a count of the number of repetitions. If the turbidity measurement at step 116 after a predetermined number of repetitions for a particular sample (e.g., three passes through steps 104-116, or two repetitions after the initial pass) does indicates that an inadequate number of cells are present, the control computer stops the cycle of repetitions. Those samples which contain inadequate numbers of cells are nonetheless processed through the slide preparation steps 118 discussed below. However, the control computer records this result and thus “tags” the sample as a sample which cannot be processed normally, and which contains an insufficient number of cells. The control computer can record this result and/or mark the slide as discussed above with respect to step 126.

As discussed above, each sample ultimately will pass to step 118, either through step 116 or through the alternate process step 126. In step 118, the fluid suspension in the cuvette is first mixed by inserting the pipette into the cuvette and fluid is alternately drawn into the pipette and discharged back into the cuvette to mix the suspension in a pipette mixing step as previously described. In such pipette mixing step, the discharge end 312 of the pipette is approximately 4.5 mm from the filter 500, as also previously described. After such pipette mixing, the pipette is then further inserted into the cuvette until the ledge 308 of the pipette abuts the ledge 412 of the pipette. In this position, the discharge end 312 of the pipette is approximately 0.5 mm from the filter 500. Then, a known amount of the fluid suspension in the cuvette is removed from the cuvette by pipette 300 and syringe pump 730 and transported to the slide 600 shown in FIG. 11 and described above. Preferably, 1000 μl of liquid is transferred from the cuvette onto the adhesive coated portion 604 of the slide within the containment boundary 606. This creates a 20 mm diameter drop or “button” of the fluid suspension on the slide. The sample placed on the slide is allowed to settle on the slide so that the cells within the sample can adhere to the adhesive coating and form a monolayer.

In a following step 120, excess liquid is aspirated from the slide by aspirating dispense head 900 through valve 716. In alternate embodiments, excess liquid can be removed by tilting the slide or by blotting excess liquid from the slide. The remaining liquid on the slide is then allowed to dry to enhance the adhesion of cells to the slide. In a further embodiment, after the cells have adhered to the slide, but before the liquid has been allowed to dry, further washing and aspirating steps are performed to remove overlapping cells or cells that have not adhered to the slide.

In a following step 122, cellular material on the slide is fixed with alcohol by dispensing alcohol by pump 760 through aspirating/dispensing head 900 onto the “button” of the fluid suspension on slide 600. A cellular stain and cover-slip is also applied so that the cells on the slide can be microscopically examined for pathology. Such examination can be performed by a laboratory technician, an automated apparatus, or a combination of both. The stains applied in the staining step may be conventional stains of the type commonly used for examination of Pap smears, or any other type of stains desired for the particular examination to be performed.

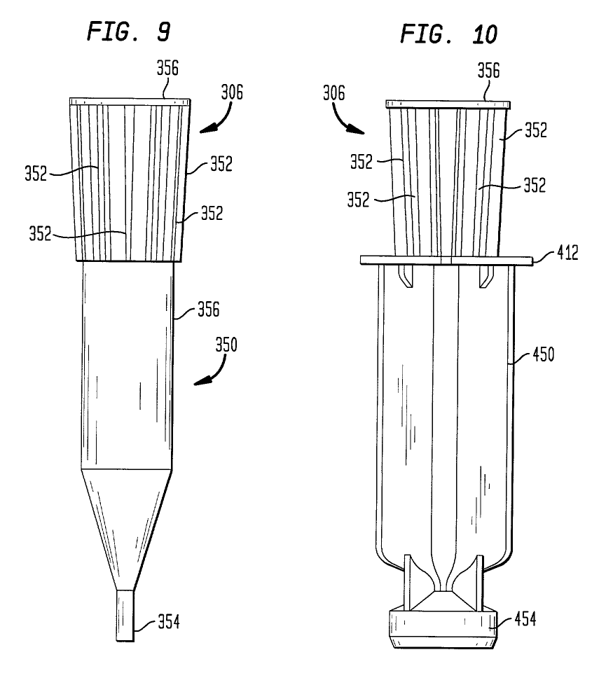

Alternate embodiments of the apparatus described above can be made. As shown in FIG. 9, in an alternate embodiment of the pipette, the upper portion of the pipette has ribs 352 extending outwards from the exterior wall of the upper portion 306 of the pipette 350. When the pipette in the embodiment in FIG. 9 having the rows of longitudinal ribs 352 is inserted into a cuvette 400, as shown in FIG. 10, the ridges 352 of the pipette 350 abut the ledge 412 of the cuvette 450 to limit movement of the pipette into the cuvette.

An alternate embodiment of the pipette is shown in FIG. 5, where the tip 312′ of the pipette includes slots 314 to preferentially filter cells and cell sheets into the pipette. As shown in FIG. 6, the slots are tapered from a wider opening side 316, closest to the extremity of the tip, to a narrower interior side 318, closest to the main body of the pipette. The width w of each slot in the circumferential direction at opening side 316 is more than the width w′ at the interior side 318 of such slot. This tapering facilitates the drawing of target cells and sheets of target cells into the pipette by aligning sheets of cells within the tapered section. As shown diagrammatically in FIG. 6, clumps of cells 332 and unwanted material 333 that are larger than the openings 316 of the tapered slots 314 are kept from being drawn into the pipette. The slots form a crude filter, integral with the pipette itself, at the tip of the pipette. In alternate embodiments of the pipette, a separate filter can be attached to the tip 312 of the pipette or inserted into the discharge opening 304 to similarly preferentially filter single cells or sheets of cells into the pipette, while excluding larger particles.

In an alternate embodiment of the cuvette 400, the entire cuvette or the portion of the cuvette where turbidity is measured can be cylindrical rather than rectangular.

In still further embodiments of the cuvette, the filter is designed to allow only a portion of some unwanted material, such as white blood cells, to pass out of the cuvette. In this manner, a portion of the white blood cells are maintained in the cuvette for cytological reference or examination.

In an alternate embodiment of the microscopic slide 600, the containment boundary 606 consists of a ring made of flexible material that seals onto the slide when a small force is applied to it. In the one such embodiment, this ring is disposable. For example, such a containment ring may be formed from an elastomeric material such as rubber, and may have features which allow the ring to engage the slide mechanically. Alternatively, the ring may be mounted to the slide by an adhesive. In another such embodiment, the slide itself does not incorporate a containment boundary. A containment ring as discussed above may be part of an automated machine for preparing microscopic slides. In such an embodiment, the containment ring would be temporarily engaged with the slide while the liquid sample is applied and disengaged from the slide after excess liquid has been aspirated from the slide. Such a ring can washed between the preparation of slides to prevent cross-contamination.

Alternate embodiments of the preferred method discussed above also can be practiced. For example, in the methods discussed above, turbidity is monitored by measuring the amount of light transmitted through the sample. However, turbidity can be measured by monitoring the amount of light scattered by the sample. For example, a sensor such as a photocell can be positioned to one side of the path of light directed into the cuvette, so that light which passes directly through the cuvette does not impinge on the sensor, but light scattered by the sample in the cuvette will impinge on the sensor. In this case, the sensor will “see” more light as the turbidity increases. Also, rather than measuring turbidity to determine the number of target cells in the cuvette, another parameter can be used to estimate the number of target cells in the cuvette. In one alternate embodiment, this parameter is the amount of filter resistance. In alternate embodiments, the sample in the cuvette is subjected to an electrical or electromagnetic interrogation which is known to be related to the number of cells in the sample. This can include, but is not limited to, optical absorbance, electrical impulses and magnetic measurements. For example, the electrical conductivity of the cells typically differs from the conductivity of the surrounding liquid. Accordingly, the conductivity of the sample provides a measure of the number of cells per unit volume in the sample.

While the steps described above are performed in combination in the preferred method, in alternate embodiments, the steps can be performed individually, in cooperation with additional steps, or in a different sequence. For example, in an alternate embodiment, after step 108 is performed and the sample is filtered to a low level, steps 112 and 114 are performed and the sample in the cuvette is resuspended and its turbidity is measured. This turbidity measurement is then used to determine the number of cells per unit volume of fluid in the sample. In a following step, a volume of sample is transferred to a slide. The volume which is transferred for a particular sample is determined based on the measurement of the number of cells per unit volume, so that a known number of cells are included in the sample which is transferred removed from the cuvette.

In an alternate embodiment, to further mix the contents of the cuvette, air is passed through pipette 300 into chamber 414 of cuvette 400 by pump 720 to introduce bubbles into the fluid within the cuvette. This “bubbling step” can be performed at various times during the described method. For example, such bubbling step can be performed after sample from the sample vial is introduced into the cuvette, prior to measuring the turbidity in step 114, prior to removing a portion of the sample from the cuvette, or at any other time sample in the cuvette is desired to be mixed. Such bubbling can also be performed during the filtering and resuspending steps discussed above.

In a still further embodiment, air for mixing is introduced into the cuvette from the downstream side 503 of the filter 500 through multi-port cuvette block 707.

The filtration and backwashing steps discussed above can be varied. For example, rather than introducing air downstream of the filter as in the embodiments discussed above, a liquid or a gas other than air can be injected into block 707 in a pulsatile fashion to provide a periodic increase in the pressure downstream of the filter and thus provide intermittent backflushing. For example, the backflushing can be done with water, preservative solution, or filtrate from the cuvette. Alternatively, the filtrate can be withdrawn from the downstream side of the filter (from block 707) by a pump which intermittently reverses direction so that the filter is intermittently backwashed with pure filtrate. Other ways of intermittently reversing the pressure differential across the filter to periodically reverse the flow can be employed. For example, a vacuum can be applied intermittently to the upstream end of the cuvette. The filtration procedures discussed above, and particularly the backwashing step, can be used with or without the other steps discussed above to recover cells for many purposes. Similarly, the introduction of fluids such as air and liquid samples by a pipette having a discharge opening proximate to the upstream side of the filter so as to mix the cells with a liquid and dislodge the cells from the filter can be used in cell recovery processes, with or without the other steps.

In alternate embodiments, the end point of the filtration step, when the liquid in the cuvette is drawn down to a low level, is determined by a capacitive fluid level sensor or by monitoring the pressure differential across the filter. This pressure differential decreases after the liquid has been filtered out of the cuvette and air reaches the upstream side of the filter. In another embodiment, an amount of target cells and unwanted material is introduced into a cuvette and the cuvette is filtered for a specified period of time to remove unwanted material. In this embodiment, it is not necessary to detect the endpoint of the filtering process as discussed above. For example, the length of the filtering time can be determined by measuring the amount of target cells in the sample before the filtering process. In a further embodiment of this method, the length of the filtering time is determined by measuring the amount of unwanted material in the sample before filtering. In a still further embodiment of this method, filtering is performed for a fixed period of time regardless of the individual parameters of the sample.

In further embodiments, the amount of sample withdrawn from the cuvette in step 118 is fixed and the amount of cellular material from the sample withdrawn into the pipette is controlled by diluting or increasing the concentration of cellular material in the sample through the addition or subtraction of fluid within the cuvette. In this way, even though a fixed amount of sample is removed from the cuvette, the amount of cellular material in the sample removed from the cuvette can be kept constant by increasing or decreasing the concentration of cellular material within the fluid in the cuvette. In such embodiments, the fluid in the cuvette is diluted by, for example, adding water to the cuvette from reservoir 785 through the multi-port cuvette block 707. The fluid may be concentrated by, for example, withdrawing fluid from the cuvette through the filter 500.

It should be understood that while some of the methods described are implemented on a series of samples, the invention also contemplates performing such methods on a single sample. Similarly, while some of the methods described are implemented on a singe sample, the invention also contemplates performing such methods on a series of samples.

It should also be understood that while the invention is generally described as relating to the preparation of a sample obtained from gynecological (Pap) smears, the invention can be used for the preparation of samples from other specimens, including bronchial washings, bronchial brushings, sputum, cerebral-spinal fluid, peritoneal washings, pleural fluids, as well as brushings from bile ducts, stomach, intestine, esophageal and endometrial tissues, and biopsies, needle aspirations, or other collections of specimens from other body cavities and tissues.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of isolating a quantity of cells, comprising the steps of:
(a) placing a sample including an amount of target cells and unwanted material into a cuvette;
(b) removing an amount of unwanted material from said sample in said cuvette;
(c) measuring at least one parameter of said sample remaining in said cuvette related to the number of target cells in said sample; and
(d) withdrawing a portion of said sample remaining in said cuvette when said parameter is within selected limits.

2. A method as claimed in claim 1, further comprising the steps of repeating steps (a) through (c) if said parameter indicates that a predetermined quantity of said target cells is not present in said sample remaining in said cuvette.

3. A method as claimed in claim 1, wherein said parameter of said sample includes the turbidity of said sample.

4. A method as claimed in claim 3, wherein said turbidity is estimated by administering an amount of light onto said sample and measuring the amount of light scattering, therein indicating the quantity of target cells per unit volume of measured sample volume.

5. A method as claimed in claim 1, further comprising the steps of adjusting the volume of said portion of said sample removed from said cuvette so that a predetermined quantity of said target cells are removed.

6. A method as claimed in claim 1, wherein said parameter of said sample is a measured amount of filter resistance.

7. A method as claimed in claim 1, wherein said step of withdrawing said portion of said sample remaining in said cuvette is initiated after a predetermined period of time after said step of placing said sample in said cuvette.

8. A method as claimed in claim 7, further comprising the step of measuring at least one second parameter related to the amount of said unwanted material in said sample and wherein said predetermined period of time is determined by said amount of said unwanted material in said sample.

9. A method as claimed in claim 7, further comprising the step of measuring at least one second parameter related to a quality of the amount of said unwanted material in said sample and wherein said predetermined period of time is determined by said quality of said unwanted material in said sample.

10. A method as claimed in claim 1, further comprising the step of mixing said sample in a sample container prior to said step of placing said sample into said cuvette.

11. A method as described in claim 10, wherein said sample container has a container liquid contained therein, whereby said sample and said container liquid form a suspension.

12. A method as described in claim 11, wherein said container liquid is a preservative.

13. A method as claimed in claim 1, wherein said portion of said sample withdrawn from said cuvette is selected so that an approximately known quantity of target cells are withdrawn.

14. A method as claimed in claim 1, wherein said sample is in the form of a suspension of cells in a fluid during said removing step.

15. A method as claimed in claim 14, further comprising the step of suspending said sample in a fluid to form said suspension.

16. A method as claimed in claim 14, wherein said step of suspending said sample in a fluid suspension is done prior to placing said sample into said cuvette.

17. A method as claimed in claim 14, wherein said fluid suspension is a liquid suspension.

18. A method as claimed in claim 17, wherein said portion of said sample withdrawn from said cuvette if fixed and further comprising the step of adding or subtracting fluid from said suspension within said cuvette while substantially retaining target cells in said cuvette so that an approximately known quantity of target cells are withdrawn.

19. A method as claimed in claim 14, further comprising the step of adding at least one reagent to said fluid suspension, said reagent selected from the group consisting of: a lysing agent, an adhesion conditioning agent, a washing agent, a mucolytic agent, an amount of preservative solution, and water.

20. A method as claimed in claim 14, further comprising the step of transferring an amount of said portion of said sample removed from said cuvette to a slide.

21. A method as claimed in claim 20, wherein said slide further has a hydrophobic boundary surrounding said area, said hydrophobic boundary facilitating containment of said portion of said sample onto said slide.

22. A method as claimed in claim 20, further comprising the step of settling a portion of said sample onto said slide to form a monolayer of cells.

23. A method as claimed in claim 22, wherein said settling step occurs on said slide within an area defined by a containment area.

24. A method as claimed in claim 22, wherein an area on said slide has an adhesive thereon, said adhesive facilitating formation of said monolayer.

25. A method as claimed in claim 22, further comprising the step of removing excess fluid of said sample from said slide after said settling step.

26. A method as claimed in claim 24, wherein said adhesive is a ultraviolet light polymerizable adhesive, the method further comprising applying ultraviolet light to said adhesive during or after said settling step.

27. A method as claimed in claim 24, wherein said adhesive is a polycationically charged polymer.

28. A method as described in claim 25, wherein said step of removing a portion of excess fluid of said sample from said slide comprises aspirating said excess fluid of said sample from said slide after said monolayer of said target cells have formed on said slide.

29. A method as described in claim 25, wherein said step of removing a portion of said excess fluid of said sample from said slide comprises draining said slide by tilting said slide after said monolayer of said target cells have formed on said slide.

30. A method as described in claim 25, wherein said step of removing a portion of said excess fluid of said sample from said slide comprises absorbing said excess from said slide after said monolayer of said target cells have formed on said slide.

31. A method as described in claim 25, further comprising the step of fixing said target cells by applying alcohol solution to said monolayer.

32. A method as claimed in claim 2, wherein said removing step comprises filtering said sample in said cuvette such that said fluid and unwanted material passes in a downstream direction through a filter connected to said cuvette having an upstream side facing the interior of said cuvette and a downstream side, said target cells being substantially retained within said cuvette on or above said upstream side of said filter.

33. A method as claimed in claim 32, wherein said suspension includes a preservative solution and said preservative solution is removed from said cuvette in said filtering step, the method further comprises replacing said preservative solution with a clean resuspension liquid prior to said step of withdrawing a portion of said sample remaining in said cuvette.

34. A method as claimed in claim 32, wherein said filtering is discontinued when a predetermined level of said sample remaining in said cuvette is obtained.

35. A method as claimed in claim 32, wherein said method further comprises the step of monitoring a pressure differential between said upstream side and said downstream side and discontinuing filtering when a predetermined level of said differential pressure is obtained.

36. A method as claimed in claim 32, wherein said step of filtering said sample remaining in said cuvette comprises applying a subatmospheric pressure on the downstream side of said filter to pull said unwanted sample material through said filter.

37. A method as claimed in claim 32, further comprising the step of passing a fluid through said filter into said cuvette in an upstream direction from said downstream side of said filter to said upstream side of said filter so as to facilitate said filtering step and further mix said sample within said cuvette.

38. A method as claimed in claim 37, wherein said step of passing fluid through said filter in said upstream direction is performed concurrently with said step of measuring a parameter of said sample remaining in said cuvette.

39. A method as claimed in claim 37, wherein said fluid is water.

40. A method as claimed in claim 37, wherein said fluid is a gas.

41. A method as claimed in claim 37, wherein said fluid is air.

42. A method as claimed in claim 37, wherein said fluid is a mixture of a liquid and gas.

43. A method as claimed in claim 37, wherein said fluid passing in said upstream direction through said filter includes filtrate which had previously passed downstream through said filter.

44. A method as claimed in claim 37, wherein said filtering step and said step of passing a fluid through said filter in said upstream direction are conducted so that fluid flows alternately in said downstream and upstream directions.

45. A method as claimed in claim 44, wherein said fluid flow alternates between upstream and downstream directions at a frequency of about 0.01 to about 50 Hz.

46. A method as claimed in claim 45, wherein said frequency is about 5 to about 15 Hz when said fluid is a liquid and is about 0.2 to 1 Hz when said fluid is a gas.

47. A method as claimed in claim 1, wherein said measuring step comprises administering an amount of electromagnetic interrogation to said sample in said cuvette and measuring a response to said interrogation, said response being associated with a property of said target cells or said unwanted material in said sample.

48. A method as claimed in claim 1, wherein said step of placing said sample into said cuvette is accomplished by a pipette.

49. A method as claimed in claim 48, wherein said step of placing said sample into said cuvette by said pipette mixes the portion of said sample in said cuvette.

50. A method of preparing a monolayer of cells, comprising the steps of:
(a) suspending a sample in a fluid, said sample including an amount of target cells and unwanted material;
(b) placing a portion of said suspended sample into a cuvette;
(c) removing an amount of said unwanted material from said suspended sample in said cuvette;
(d) measuring at least one parameter of said sample remaining in said cuvette related to the number of said target cells in said sample;
(e) repeating steps (b) through (d) if said parameter indicates that a predetermined quantity of said target cells is not present in said sample remaining in said cuvette;
(f) withdrawing a portion of said sample remaining in said cuvette when said parameter is within selected limits; and
(g) transferring said withdrawn portion to a slide.

51. A method as claimed in claim 50, further comprising the step of resuspending said sample in a fluid after said removing step and prior to said step of measuring at least one parameter of said sample remaining in said cuvette.

52. A method of automatically preparing series of monolayers of cells from a series of samples, comprising the steps of:
(a) suspending each sample in a fluid, said sample including an amount of target cells and unwanted material;
(b) placing a portion of each said suspended sample into a cuvette;
(c) removing an amount of said unwanted material from each said suspended sample in said cuvette;
(d) for at least some of said samples, measuring at least one parameter of the sample remaining in the cuvette containing that sample, said parameter being related to the number of said target cells in that sample remaining in the cuvette;
(e) for at least some samples subjected to step (d), repeating steps (b) through (d) for a particular sample if said parameter for that sample indicates that a predetermined quantity of said target cells is not present in that sample remaining in said cuvette;
(f) for at least some of those samples subjected to step (d) withdrawing a portion of said sample remaining in said cuvette when said parameter is within selected limits; and
(g) transferring at least a part of each said withdrawn portion to a slide.

53. A method as claimed in claim 52, wherein said parameter of said sample includes the turbidity of said sample.

54. A method as claimed in claim 52, further comprising the step of resuspending said sample in a fluid after said removing step and prior to said step of measuring at least one parameter of said sample remaining in said cuvette.

55. A method as claimed in claim 53, wherein said turbidity is estimated by administering an amount of light onto said sample and measuring the amount of light scattering, therein indicating the quantity of said target cells per unit volume of measured sample volume.

56. A method as claimed in claim 52, further comprising the step of determining whether said removing step has been completed within a predetermined time, and subjecting to step (d) only those samples for which said removing step is completed within a predetermined time, the method further comprising withdrawing a portion of each sample which is not subjected to step (d) and transferring the withdrawn portion to a slide.

57. A method as claimed in claim 56, wherein said removing step includes filtering substantially all fluid from the sample.

58. A method as claimed in claim 57, further comprising the step of resuspending said sample in a fluid after said removing step and prior to said step of measuring at least one parameter of said sample remaining in said cuvette.

59. A method as claimed in claim 52, wherein all of said samples are subjected to step (d).

60. A method of preparing a monolayer of cells, comprising the steps of:
(a) suspending a sample in a fluid, said sample including an amount of target cells and unwanted material;
(b) placing a portion of said suspended sample into a cuvette;
(c) removing an amount of unwanted material from said suspended sample in said cuvette;
(d) measuring the length of time from a period starting at the initiation of said step of removing an amount of unwanted material from said suspended sample in said cuvette;
(e) withdrawing a portion of said sample remaining in said cuvette when said period of time reaches a predetermined period; and
(f) transferring said withdrawn portion to a slide.

61. A method as claimed in claim 60, further comprising the step of measuring at least one parameter of said sample related to the number of said target cells in said sample, and wherein said predetermined period is related to said number of said target cells in said sample.

62. A method as claimed in claim 60, further comprising the step of measuring at least one parameter of said sample related to a quality of said unwanted material in said sample, and wherein said predetermined period is related to said quality of said unwanted material in said sample.

63. A method as claimed in claim 60, further comprising the step of measuring at least one parameter of said sample related to a quantity of said unwanted material in said sample, and wherein said predetermined period is related to said quantity of said unwanted material in said sample.

64. A method as claimed in claim 60, further comprising the step of resuspending said sample in a fluid after said removing step and prior to said step of withdrawing a portion of said sample remaining in said cuvette.

65. A method of preparing a monolayer of cells, comprising the steps of:
(a) suspending a sample in a fluid, said sample including an amount of target cells and unwanted material;
(b) placing a portion of said suspended sample into a cuvette;
(c) removing an amount of unwanted material from said suspended sample in said cuvette;
(d) measuring at least one parameter of said sample related to the number of said target cells in said sample;
(e) measuring the length of time from a period starting at the initiation of said step of removing an amount of unwanted material from said suspended sample in said cuvette;
(f) repeating steps (b) through (d) if said parameter indicates that a predetermined quantity of said target cells is not present in said sample remaining in said cuvette; and
(g) transferring said withdrawn portion to a slide.

66. A method as claimed in claim 65, further comprising the step of withdrawing a portion of said sample remaining in said cuvette when said period of time reaches a predetermined period.

67. A method as claimed in claim 65, further comprising the step of withdrawing a portion of said sample remaining in said cuvette when a predetermined number of repetitions of said steps (b) through (d) have been completed.

68. A method of collecting cells, comprising the steps of:
(a) providing a suspension including cells and a liquid in a container having an interior, an aperture in communication with said interior, and a filter sized so that said cells cannot pass through such filter, said filter having an upstream side facing the interior of said container and a downstream side;
(b) causing fluid to flow fluid through said filter in an alternating manner in a downstream direction from said upstream side of said filter to said downstream side of said filter and in an upstream direction opposite to said downstream direction.

69. A method of collecting cells, comprising the steps of:
(a) introducing a quantity of cells and a fluid into a container having an interior, an aperture in communication with said interior, and a filter covering said aperture so that at least a portion of said cells cannot pass through said filter,
(b) filtering said fluid through said filter, thereby collecting said portion of said cells in said container, at least a portion of said fluid being withdrawn and reintroduced into said container proximate enough to said filter to reduce blockage of said filter.

70. A method as claimed in claim 69, wherein at least a part of said step of introducing said fluid is performed contemporaneously with said step of filtering said liquid.

71. A method as claimed in claim 69, wherein said quantity of cells is suspended in said fluid prior to said step of introducing said quantity of cells and said fluid into said container.

72. A method of collecting cells, comprising the steps of:
(a) providing a quantity of cells and a fluid in a container having an upstream interior section, a downstream interior section and a choke having a lesser cross-sectional area than said upstream and downstream sections, said upstream and downstream sections communicating with one another through said choke, said container also having a filter remote from said choke in communication with said downstream interior section, said filter being sized so that at least a portion of said cells cannot pass through said filter; and
(b) drawing said fluid from said upstream interior section through said choke, said downstream interior section and said filter, such that fluid passing through said choke facilitates mixing of said fluid and said cells in said downstream section.

73. An apparatus for holding and mixing specimens, comprising:
(a) a container having at least one wall defining an interior space and an opening;
(b) at least one projection projecting from said wall into said interior space, said projection adapted to facilitate transfer of specimens into said interior of said container and facilitate mixing of specimens placed into said interior of said container.

74. The apparatus as claimed in claim 73, wherein said projection is adapted to facilitate transfer of specimens from a spatula.

75. The apparatus as claimed in claim 73, wherein said projection is adapted to facilitate transfer of specimens from a brush.

76. The apparatus as claimed in claim 73, further comprising a cap releasably attached to said container for closing said opening.

77. The apparatus as claimed in claim 73, wherein said projection includes at least two fingers extending from said wall into said interior space.

78. The apparatus as claimed in claim 77, wherein said at least two fingers are spaced apart from one another by about 1 to about 6 mm.

79. An apparatus for collecting cells from a fluid, comprising:
(a) a container having an upstream interior section, a downstream interior section, and a choke having a lesser cross-sectional area than said upstream and downstream sections, said upstream and downstream sections communicating with one another through said choke; and
(b) a filter remote from said choke in communication with said downstream interior section, said filter being sized so that at least a portion of said cells cannot pass through said filter, whereby when a fluid is drawn from said upstream interior section through said choke, said downstream interior section, and said filter, movement of fluid passing through said choke facilitates mixing of said fluid and said cells in said downstream section.

80. An apparatus as claimed in claim 79, further comprising:
a pipette for introducing said fluid into said container, said pipette having a first end adapted to pass through said intermediate interior section of said container so that fluid can be introduced into said container in said second interior section.

81. An apparatus as claimed in claim 79, further comprising:
a pipette for withdrawing said fluid from said container, said pipette having a first end adapted to pass through said intermediate interior section of said container so that fluid can be withdrawn from said second interior section of said container.

82. An apparatus as claimed in claim 80, wherein at least one of said pipette and said container has a stop operable to prevent said first end of said pipette from coming into contact with said filter.

83. An apparatus as claimed in claim 80, wherein at least one of said pipette and said container has a stop operable to direct said first end of said pipette to a point proximate to said filter.

84. Apparatus for filtering cells from a liquid comprising:
(a) an container having an interior space, an opening at an upstream end of said interior space, and a filter adapted to retain cells, said filter communicating with said interior space downstream of said opening; and
(b) a pipette having a discharge opening, said pipette being constructed and arranged so that said pipette can be positioned within said interior space, at least one of said pipette and said container has a stop operable to arrest motion of said pipette into said opening so that said discharge opening of said pipette is disposed proximate to said filter when said stop arrests said motion.

85. An apparatus as claimed in claim 84, wherein said pipette is disposed about 0.1 mm to about 1 mm to said filter.

86. A slide assembly for microscopic examination of cells, comprising:
(a) a slide having a surface;
(b) an adhesive coating on at least a portion of said surface; and
(c) a ring surrounding a portion of said adhesive coating, said ring having a lower surface energy than said adhesive portion.

87. A slide as claimed in claim 86, wherein said ring is substantially transparent to the light used for microscopic examination.

88. A slide as claimed in claim 86, wherein said ring is substantially transparent to visible light.
